(19) United States
(12) Patent Application Publication
(10) Pub. No.: US 2017/0364944 A1
(43) Pub. Date: Dec. 21, 2017

(54) SYSTEMS AND METHODS FOR EFFICIENT PROCESSING OF LARGE SCALE PROPAGATION OF RESOURCES AMONG ACCOUNTS

(71) Applicant: Visa International Service Association, San Francisco, CA (US)

(72) Inventors: Varun Sharma, SINGAPORE (SG); Santosh Lachhman Achhra, SINGAPORE (SG); STANISLAV IGOREVICH TSIKINE, San Jose, CA (US); Ajit Vilasrao Patil, SINGAPORE (SG); Sergey Alex Paykis, Belmont, CA (US); Srijoy Aditya, Los Altos, CA (US); NANDAKUMAR KANDALOO, Mountain View, CA (US)

(21) Appl. No.: 15/183,688

(22) Filed: Jun. 15, 2016

(51) Int. Cl. G06Q 30/02; G06Q 20/40; G06Q 20/20; G06Q 50/00; H04L 29/06

(52) U.S. Cl. CPC G06Q 30/0241; G06Q 50/01; H04L 63/20; G06Q 20/206; G06Q 20/405; H04L 2463/102

(57) ABSTRACT

Accounts are grouped via database connections to form account groups that can be used to efficiently track the propagation of resources or privileges. Virtual accounts can be grouped via non-replaceable connections, where each of the virtual accounts is limited for online transactions with a predefined website without a respective account identification device for presenting account identification information to a reader of a transaction terminal for offline transactions. A primary account in a non-replaceable group of virtual accounts may include (or be linked to) resources and/or privileges that can be propagated to the secondary accounts in the non-replaceable group. The primary account may be a virtual account, or a non-virtual account.

### RELATED APPLICATIONS

The present application relates to U.S. patent application Ser. No. 15/163,047, filed May 24, 2016 and entitled “Systems and Methods to Organize Data Supporting Efficient Processing of Large Scale Propagation of Resources among Users of Accounts”, which claims priority to Prov. U.S. Pat. App. Ser. No. 62/169,429, filed Jun. 1, 2015 and entitled “Systems and Methods to Organize Data Supporting Efficient Processing of Large Scale Offer Propagation”, the entire disclosures of which are hereby incorporated herein by reference. The present application also relates to U.S. patent application Ser. No. 14/021,673, filed Sep. 9, 2013, published as U.S. Pat. App. Pub. No. 2014/0074575, and entitled “Systems and Methods to Program Interaction with a User through Transactions in Multiple Accounts,” the entire disclosure of which is hereby incorporated herein by reference.

### FIELD OF THE TECHNOLOGY

At least some embodiments of the present disclosure relate to the organization of data in general and more particularly but not limited to the organization of data to support efficient processing of large scale offer propagation.

### BACKGROUND

U.S. Pat. App. Pub. No. 2014/0074575 discloses a system that allow a user to use any of a plurality of registered accounts to participate in an offer campaign, where the offer campaign is programmed by offer rules that identify the real time interactions with the user in response to the actions of the user, such as transactions made using any of the registered accounts of the user. The offer campaign for the user is driven at least in part by the actions of the user, such as the transactions made by the user. In one embodiment, transactions in the registered accounts of the user jointly advances the offer campaign for the user; and a milestone achieved in the offer campaign using one account of the user is recognized as a milestone achieved by the user with respect to the multiple registered accounts. Thus, the offer campaign for the user can be advanced by the user via different accounts, as if the registered accounts were a same account; and the user is not limited to using a particular account to participate in the offer campaign, nor using different accounts to drive the offer campaign separately, as if the accounts were assigned to different users.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a technique to organize accounts into groups according to one embodiment.

FIG. 2 illustrates an example of a replaceable account group according to one embodiment.

FIG. 3 illustrates a data storage pattern of a replaceable account link according to one embodiment.

FIG. 4 illustrates an example of a non-replaceable account group according to one embodiment.

FIG. 5 illustrates a data storage pattern of a non-replaceable account group according to one embodiment.

FIG. 6 shows a system to process offers via account groups according to one embodiment.

FIG. 7 shows a system to process offer rules in response to transactions in a plurality of accounts of a user according to one embodiment.

FIG. 8 shows a system to provide information based on transaction data according to one embodiment.

FIG. 9 illustrates a transaction terminal according to one embodiment.

FIG. 10 illustrates an account identifying device according to one embodiment.

FIG. 11 illustrates a data processing system according to one embodiment.

FIG. 12 shows a virtual account configured in an electronic payment processing network according to one embodiment.

FIG. 13 shows a virtual account group according to one embodiment.

### DETAILED DESCRIPTION

In a computing system, resources are typically allocated to accounts. A resource allocated to a particular account is typically restricted in access to the user(s) of the particular account.

However, there are many applications that would allow users of different accounts to share and/or redistribute resources allocated to their accounts. It is a challenge to manage the sharing and/or redistribution of a large number of resources across a large number of accounts.

One solution provided in the present application includes the organization of accounts into groups via links between accounts and groups. Links have predefined types, such as replace links (or replaceable connections) and non-replace links (or non-replaceable connections). The predefined types of links define the resource sharing/distribution relations among the linked accounts in a predetermined way, such that the sharing and/or redistribution of resources can be efficiently tracked via the links. Through the identification of the account relations made via the links, the access restrictions and/or privileges to the resources can be indirectly tracked and/or determined in a scalable manner for a large number of accounts and a large number of resources.

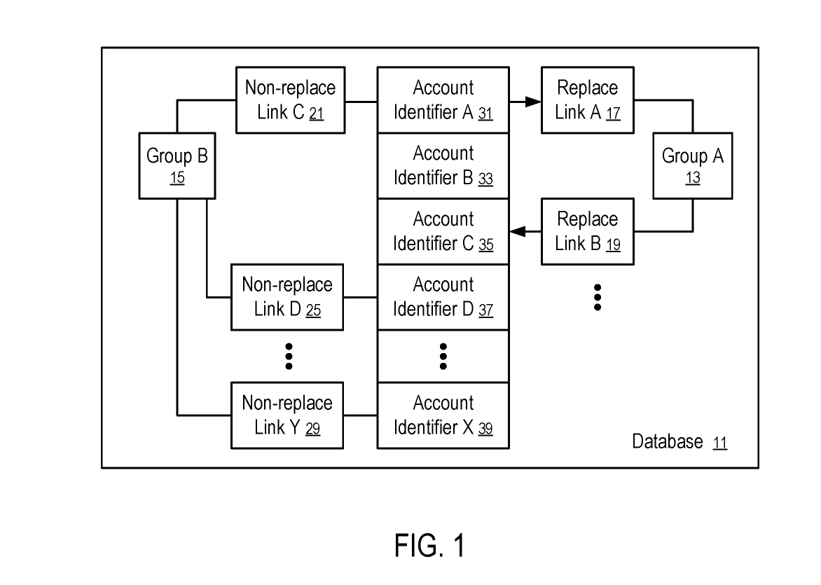

FIG. 1 shows a technique to organize accounts into groups according to one embodiment.

In FIG. 1, a set of accounts identified via their account identifiers (31, 33, 35, 37, . . . , 39) are organized into various account groups (e.g., 13, 15) via predefined types of links (e.g., 17, 19, . . . , 21, 25, . . . , 29) in the database (11). Each of the group (e.g., 13, or 15) is connected with accounts using only one type of link (e.g., replace link (17, 19), or non-replace link (21, 25, . . . , 29)). Each account can be optionally linked to one or more groups (e.g., 13, 15).

Replace links (e.g., 17, 19) establish replaceable connections between accounts (e.g., 31, 35) such that a replaced account (e.g., 35) is replaceable by a replacement account (e.g., 31) in that the resources of the replaced account (e.g., 35) are accessible by the replacement account (e.g., 31); however, resources of the replacement account may not be accessed by the replaced account. The replace links (e.g., 17, 19) are directional in the group (e.g., 13) in identifying the accounts (e.g., 35) being replaced by other accounts (e.g., 31) and the accounts (e.g., 31) replacing other accounts (e.g., 35). In general, a first account can be replaced by a second account, which can be further replaced by a third account. An account may replace one or more accounts in a group. The database (11) stores data records to identify the replace links (e.g., 17, 19) that connect accounts (e.g., 31, 35) and the account groups (e.g., 13).

Non-replace links (e.g., 21, 25, . . . , 29) establish non-replaceable connections among accounts (e.g., 31, 37, . . . , 39) in a group (e.g., 15). Resources can be shared and/or redistributed within the group (e.g., 15). Within a group (e.g., 15) established via non-replace links (e.g., 21, 25, . . . , 29), one or more accounts may be identifier as being primary in the group (e.g., 15). A primary account in the group is allowed to share and/or redistribute its resources to other accounts in the group. Non-primary accounts (secondary accounts) in the group are not allowed to share and/or redistribute their resources within the group. A primary account in a group may grant a non-primary account permissions to share and/or redistribution resources, obtained from the primary account in the group, via other account groups connected via non-replace links. The database (11) stores data records to identify the non-replace links (e.g., 21, 25, . . . , 29) that connect accounts (e.g., 31, 37, . . . , 39) and the account groups (e.g., 15).

The flexibility of the non-replace links and replace links in database (11) to organize the accounts of various groups in different hierarchies allow the database (11) to efficiently track the sharing and redistribution of resources in a scalable manner that supports a large number of accounts and the sharing and redistribution of large number of resources.

For example, the resources can be in the form of offers provided to the account holders. The accounts can be grouped via replaceable connections and non-replaceable connections to form account groups in tracking the propagation of offers among users of the accounts. For example, users of an offer propagation platform may split an offer into sub-offers and share sub-offers with varying benefits with others; and permissions may be provided to further split the sub-offers. Using non-replace links to form a group, the splitting of one or more offers by a primary account in the group and sharing of the sub-offers with other accounts in the group can be efficiently tracked in reference to the account group. Further splitting of a sub-offer can be similarly tracked in a separate group. Accounts that can be treated as a same account are linked/grouped via replace links (replaceable connections). Accounts having different ownerships are grouped via non-replaceable connections during offer sharing and/or distribution from primary accounts to secondary accounts in respective account groups. Thus, the tracking of the division/propagation/distribution of the offers can be performed via the database (11) in an efficient and scalable manner. As a result, the offer propagation platform can operate with the capability of supporting linked accounts in millions, allowing offers to be propagated among users via sharing, redistribution and/or subdivision for improved usage.

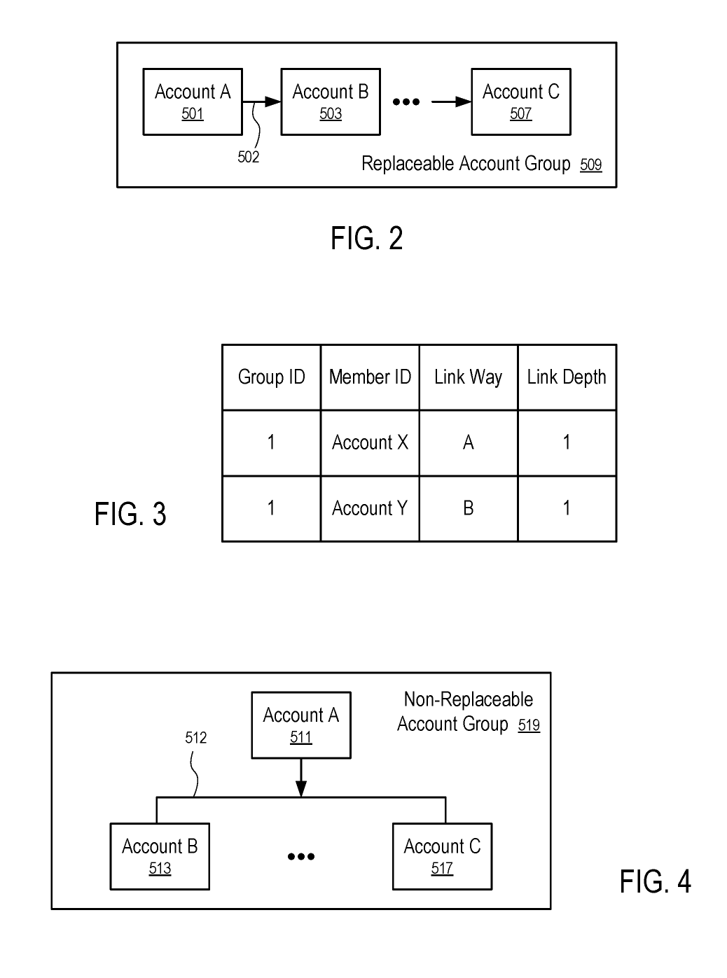

FIG. 2 illustrates an example of a replaceable account group according to one embodiment. The replaceable account group can be implemented using the technique of replace links illustrated in FIG. 1.

In FIG. 2, a replaceable account group (509) is provided to support situations where a user wants to use the account group to represent a set of accounts (501, 503, . . . , 507) of the user in a replaceable manner such that an account (e.g., 501) in the group is replaceable by another account (e.g., 503) in the account group (509). Using a replaceable account group (509) to represent the accounts of the user in an offer propagation system avoids a combinatorial explosion of account relations and makes it easier for a user to share offers from multiple accounts in one place.

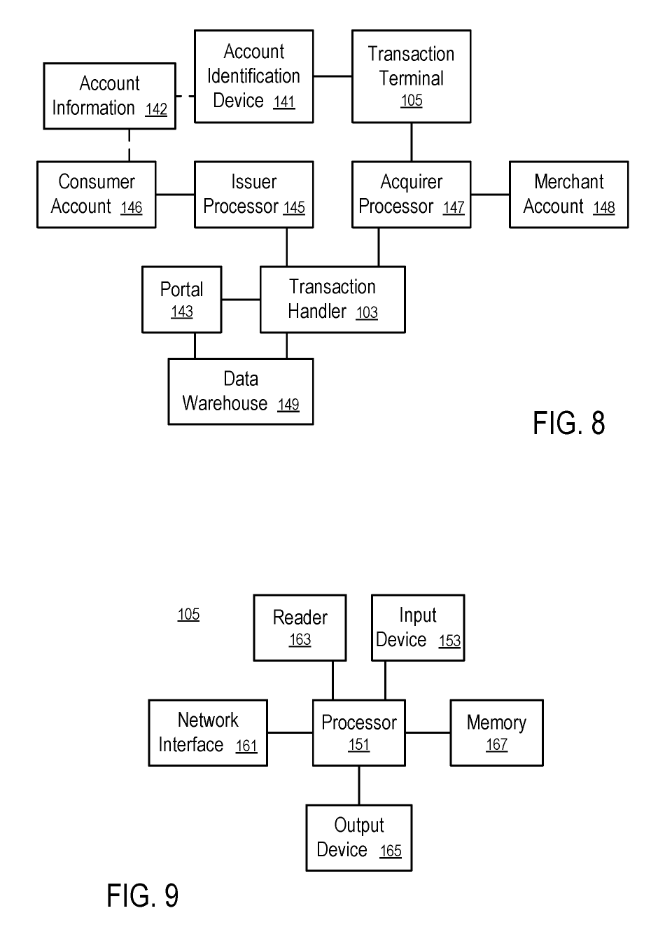

In FIG. 2, each of the accounts (501, 503, . . . , 507) represents a consumer payment account (e.g., 146) controlled by an issuer or issuer processor (145) in an electronic payment processing network illustrated in FIG. 8.

In FIG. 2, each account (e.g., 501) is identified as being replaceable by one account (e.g., 503) via a replaceable connection (e.g., 502) between the replaced account (e.g., 501) and the replacement account (e.g., 503).

In some instances of a replacement account group (e.g., 509), an account (e.g., 501) may be directly replaced by more than one account (e.g., 503) via multiple replaceable connections between the replaced account (e.g., 501) and the replacement accounts (e.g., 503).

In some instances of a replacement account group (e.g., 509), more than one account (e.g., 503) may be replaced by one account (e.g., 507) via multiple replaceable connections between the replaced accounts (e.g., 503) and the replacement account (e.g., 507).

For example, a replaceable account group (509) can be used to organize a set of accounts (e.g., 501, 503, . . . , 507) where one or more replacement account replaces a lost, stolen, upgraded, converted, and/or reused account.

For example, after the account A (501) is lost or stolen, the account B (503) can be linked to the account A (501) via a replaceable connection (502) that indicates that the account A (501) is replaceable by account B (503) in inheritance of privileges/offers received in account A (501). Thus, a privilege/offer received in the account A (501) is considered as also received in the account B (503).

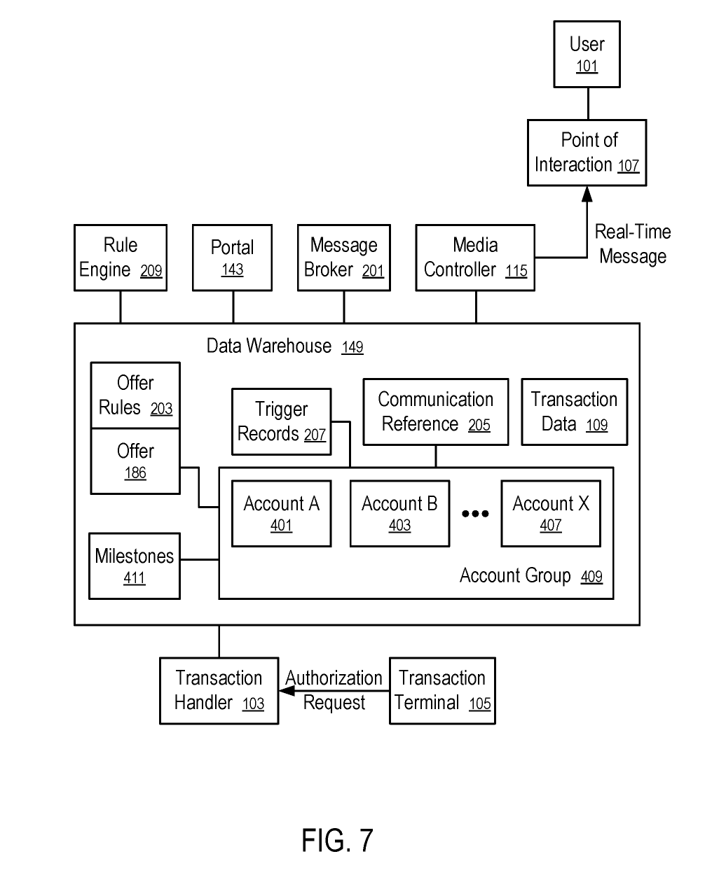

In general, a replaceable account group (e.g., 509) identifies one or more replacement accounts of one or more replaced accounts in a replacement hierarchy. A replacement account is generally allowed to inherent the privilege of the replaced account. Thus, offers associated with the accounts in the replaceable group can automatically propagate from one account to another in the group without storing addition data and/or additional input from the user. The structure and the use of the replaceable account group (e.g., 509) also allow a user to easily propagate the offers of the user among the accounts of the user in the group. For example, if a user having different consumer payment accounts (e.g., 146), the user may link the consumer payment accounts (e.g., 146) via replaceable connections (e.g., 502) to allow the propagation offers receives in one account to other accounts such that the user may use the other accounts to take advantages of the offer. For example, accounts linked via the replaceable links (e.g., 502) may be treated as the account group (409) in FIG. 7 to allow the user to use any of the accounts to participate in the offer campaign.

In some instances, when the benefit of an offer (186) is provided based on a particular attribute of the account (e.g., an identity of the issuer, an account privilege level of the account) and when the account (e.g., 401) used to initiate a payment transaction does not have the particular attribute, the transaction handler (103) is configured to use the replaceable account links (502) specified in the replaceable account group (509) identified for the offer (186) to identify an account that has the particular attribute and modify the transaction during the authorization of the transaction such that the transaction is made in the account identified via the replaceable account group (509), instead of the account used on the transaction terminal (105) to initiate the transaction.

A user interface can be provided via a portal (e.g., 143 illustrated in FIG. 6, 7, or 8) to allow a user to add or delete a replaceable account link (502) between a primary account (e.g., 501) and a linked account (503) in a replacement account group (509). The replaceable account connection (502) specifies a replaceable relation between the primary account (501) and the linked account (503) such that the primary account (501) can be replaced by the linked account (503) in an offer program. Thus, an offer (502) associated with the primary account (503) is considered to be also associated with the linked account (502).

FIG. 3 illustrates a data storage pattern of a replaceable account link according to one embodiment. The data storage technique of FIG. 3 can be used to implement the replaceable connection (502) in FIG. 2 and/or the replace links (17, 19) in FIG. 1.

In FIG. 3, the replaceable connection (502) is represented by two rows of data, each including data fields such as group ID, member ID, link way and link depth.

The group ID identifies the replaceable account group (509) among a plurality of replaceable account groups in the system.

The member ID identifies one of the accounts linked via the replaceable link (502).

The link way identifies the direction of the replaceable link (502) in relation with the respective account identified in the field member ID. For example, in the example of FIG. 3, the account X has the link way “A”, which indicates that the account X is a replaced account in the replaceable link (502); and the account Y has the link way “B”, which indicates that the account Y is a replacement account in the replaceable link (502) represented by the two row of the data illustrated in FIG. 3.

The link depth identifies the hierarchy of the replaceable link (502) in the replaceable account group (509) identified by the group ID. The link depth of 1 in the example of FIG. 3 indicates that the replacement link (502) represented by the two row of the data illustrated in FIG. 3 is the top level replacement link (502), and a replaceable link from account B (503) would have a link depth of 2.

There may be restrictions on the accounts that can be linked via replaceable connections. The replaceability of one account by another account may be restricted by certain rules of an offer/privilege.

For example, an offer may specify a rule indicating that a primary account (503) and a linked account (501) linked by a replaceable connection (502) is valid for the offer only when the primary account (503) and the linked account (501) are from the same issuer.

For example, an offer may specify a rule indicating that a primary account (503) and a linked account (501) linked by a replaceable connection (502) is valid for the offer only when the primary account (503) and the linked account (501) are issued to the same account holder.

For example, an offer may specify a rule indicating that a primary account (503) and a linked account (501) linked by a replaceable connection (502) is valid for the offer only when there is no account degradation in the direction of the prorogation of the offer between the accounts.

For example, an offer may specify a rule indicating that a primary account (503) and a linked account (501) linked by a replaceable connection (502) is valid for the offer only when the account holders of the primary account and the linked accounts are in a same predetermined user group (e.g., Ultra High Net Worth Individuals (UHNWI)), or another attribute of the transaction profile of the user.

For example, an offer may specify a rule indicating that a primary account (501) and a linked account (503) linked by a replaceable connection (502) is valid only after the approval is granted by the issuer of the primary account (501) and/or the issuer of the linked account (503).

Some of the accounts in the replaceable account group (509) can be an online account used to identify a user (e.g., in a social networking environment). For example, the top level primary account (501) in a replaceable account group (509) may be an online account of the user in a social networking website. Thus, the user may share the information about the account (501) with other users and/or offer providers to receive offers/privileges without having to disclose the account information of payment accounts (e.g., 503, . . . , 507). For example, the user may organize certain payment accounts in a separate online account (503) in the social network website, and use the replaceable line (502) to propagate the offers from the primary account (501) to the online account (503) and thus the payment accounts organized in a replaceable account group of the online account (503).

FIG. 4 illustrates an example of a non-replaceable account group according to one embodiment. The replaceable account group can be implemented using the technique of non-replace links illustrated in FIG. 1.

Non-replaceable connections are configured to link a primary account (511) and one or more secondary accounts (513, . . . , 517) in a non-replaceable account group (519). In the non-replaceable account group (519), the secondary accounts are not replacements of the primary account; and rules are explicitly specified for the non-replaceable links to propagate, distribute, or re-distribute privileges from the primary account to the linked secondary accounts.

Some of the accounts (511, 513, . . . , 517) in the non-replaceable account group (519) can be the online accounts in the social networking website (e.g., the online account of a user of the primary account (511) and the online accounts of friends and/or family as the secondary accounts (513, . . . , 517)) and/or the payment accounts known to the user.

A user interface can be provided via a portal (e.g., 143 illustrated in FIG. 6, 7, or 8) to receive, from a user of the primary account (511), inputs identifying the secondary accounts (513, . . . , 517) linked to the primary account (511) via the non-replaceable connections (512). The primary account (511) and the linked secondary accounts (513, . . . , 517) form an account group (519) such that offers received in the primary account can be cascaded (e.g., propagated/distributed/redistributed) to the linked secondary accounts (513, . . . , 517) in an automated way without receiving further user instructions.

A non-replaceable link (513) between the primary account (511) and a secondary account (519) may specify whether or not the secondary account is allowed to further cascade (e.g., propagate/distribute/redistribute) the privilege received from the primary account (511) via the non-replaceable link (512). If the secondary account (513) is allowed to further cascade the privilege that was received from the primary account (511) via the non-replaceable links (512), the user of the secondary account (513) may specify one or more further secondary accounts (e.g., via another non-replaceable account group similar to the group (519)) to cascade the received privilege to the further secondary accounts linked to the secondary account (513).

The user interface provided via the portal (e.g., 143 illustrated in FIG. 6, 7, or 8) may allow each user to specified at least one non-replaceable account group identifying a primary account (511) of the user and one or more secondary accounts (513) of friends of the user (e.g., friends in a social networking site). When a user received a privilege cascaded to the account (511) of the user via the account (511) being linked to a primary account of another user that allows the received the privilege to be re-cascaded, the system then follows non-replaceable links (512) from the primary account (511) of the user to the secondary accounts (513, . . . , 517) of friends of the user to further cascade the privilege received in the account (511) of the user.

After the user receives a privilege cascaded from an account of a friend via a non-replaceable link and the link allows the user to further cascade the received privilege, the user is prompted to provide an input indicating whether the user wants to further cascade the received privilege. In some instances, the user may specify different non-replaceable account groups for cascading different received privileges. Thus, the user may select a non-replaceable account group from the different non-replaceable account groups for the cascading of the particular received privilege, or create a non-replaceable account group (519) specifically for the particular received privilege.

When a privilege is permitted to be inherent ed from a primary account and a linked account linked via a replaceable link, the system automatically propagates the privilege received by the user in the account of the user via the replaceable account group of the user.

For example, an offer provider (e.g., a merchant or an issuer) may generate a resource or privilege (e.g., a discount offer, a loyalty reward offer) in an account of the offer provider and create an non-replaceable account group linking the account of the offer provider as a primary account to accounts of their patrons as secondary accounts using non-replaceable links, in a way as illustrated in FIG. 4. The offer provider may identify a portion or all of the secondary accounts as being permitted to re-cascade their received privilege such that their patrons may further propagate the privileges to their friends via their selections of non-replaceable account groups and/or replaceable account groups.

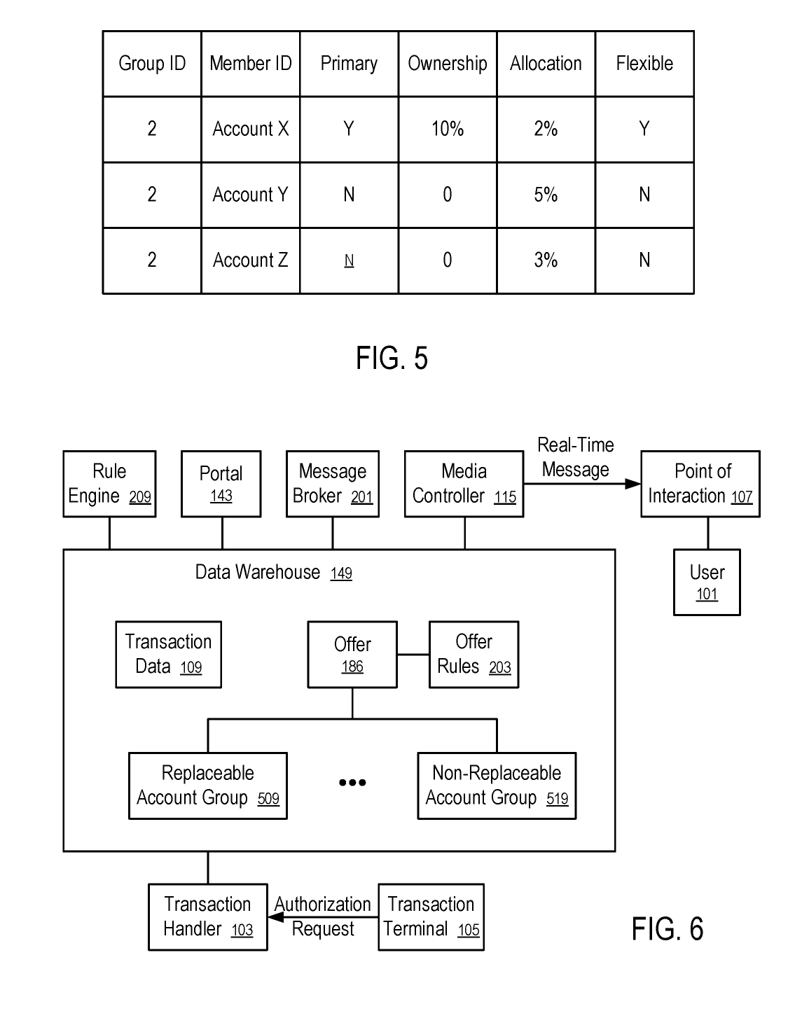

FIG. 5 illustrates a data storage pattern of a non-replaceable account group according to one embodiment. The data storage technique of FIG. 5 can be used to implement the non-replaceable connection (512) in FIG. 4 and/or the non-replace links (21, 25, . . . , 29) in FIG. 1.

In FIG. 5, three rows of data are used to identify a primary account (Account X) linked to two secondary accounts (Account Y and Account Z). Each of the rows includes data fields such as group ID, member ID, primary, ownership, allocation, flexible, etc.

The group ID identifies the non-replaceable account group (519) among a plurality of non-replaceable account groups.

The member ID identifies the respective account (e.g., 511, 513, . . . , 517) involved in the non-replaceable link (512).

The primary identifies whether the respective account is a primary account in the non-replaceable account group (519) identified by the group ID. For example, the “Y” in primary specified for “Account X” indicates that “Account X” is the primary account (511) in the non-replaceable account group (519) identified by the group ID; and the “N” in primary specified for “Account Y” indicates that “Account Y” is a secondary primary account (511) in the non-replaceable account group (519) identified by the group ID.

In FIG. 5, the ownership indicates an offer of 10% off for a purchase from a predetermined merchant received in “Account X”. The allocation of 2%, 5%, and 3% for Accounts X, Y and Z represents that the 10% discount offer is subdivided into 2%, 5%, and 3% discount offers for the redistribution to Accounts X, Y and Z respectively.

The “Y” in the flexible filed specified for Account X indicates that the user of Account X is allowed to cascade the offer to secondary accounts; and the “N” in the flexible filed specified for Account Y indicates that the user of Account Y is not allowed to cascade the offer to the friends of Account Y.

FIG. 6 shows a system to process offers via account groups according to one embodiment. For example, the system of FIG. 6 can be used to track the sharing and/or distribution of offers using the techniques of replaceable and non-replaceable account groups illustrated in FIGS. 1-5.

In FIG. 6, the offer (186) is linked to account groups (e.g., 509 and 519). The portal (143) is configured to generate trigger records according to the account groups (e.g., 509 and 519) to detect the qualified transactions that are relevant to the offer (186).

FIG. 6 shows a system to process offer rules in response to transactions in a plurality of account groups (e.g., 509 and 519) according to one embodiment. In FIG. 6, the data warehouse (149) is configured to store data representing an account groups (e.g., 509 and 519). The consumer accounts identified by the account groups (e.g., 509, and 519) may be issued by the same issuer, or different issuers, and may be of a same type, or different types (e.g., credit, debit, prepaid, etc., or preferred, gold, platinum, etc.).

In FIG. 6, the data warehouse (149) stores the offer (186) and its associated offer rules (203). In one embodiment, the offer rules (203) are specified via events linked with prerequisite conditions, in a way as discussed in U.S. Pat. App. Pub. No. 2012/0078697, entitled “Systems and Methods to Program Operations for Interaction with Users”, the entire disclosure of which is hereby incorporated herein by reference.

In FIG. 6, the data warehouse (149) stores data to associate the offer (186) with the account groups (509, 519) to allow the transactions in the account groups (509, 519) to drive the actions specified in the offer rules (203) for the offer (186).

For example, the offer (186) is initially associated with the replacement account group (509) of a user (101) based on an action of the user (101). When the transaction profile of the user (101) satisfies the requirement of the offer (186), the offer (186) is presented to the user (101) via the media controller (115). The offer (186) may be presented to the user (101) in response to a transaction in the replacement account group (409) that satisfies one or more requirements of the offer (186), or in response to the user (101) visiting the portal (143). After the user (101) accepts the offer (186), the data warehouse (149) stores data to associate the offer (186) and the replacement account group (409) of the user (101). The user (101) may further create a non-replaceable account group (519) for the subdivision and/or redistribution of the offer (186) to friends in accordance with the offer rules (203). The friends may specify replaceable account groups of their accounts and further non-replaceable account groups to further subdivision and/or redistribution of the offer (186) to the friends of the friends.

The rule engine (209) or the portal (143) of one embodiment is configured to generate trigger records (207) to detect transactions that are made in the accounts identified in the account group (e.g., 509 and 519) associated with the offer (186) and that satisfy the requirements for next actions in accordance with the offer rules (203). The data warehouse (149) stores data indicating the milestones (411) achieved in the replaceable account group (509) collectively as a whole and separately for accounts not in a replaceable relation.

The milestones (411 in FIG. 7) achieved for the offer are tracked by the current position of the replaceable account group (509) in the chain of events linked by prerequisite conditions. The current position is tracked for the replaceable account group (509) as a whole, instead of for individual accounts in the replaceable account group (509). Thus, the transactions in different accounts in the account group have similar opportunities to advance the current position of the account group (409) in the offer (186) or offer campaign.

Further details about the processing of transactions in a replaceable account group (509) are discussed in connection with account group (409) of FIG. 7.

For example, the computing apparatus can be configured to allow a user to use any of a plurality of registered accounts to participate in an offer campaign, such as performing transactions in the registered accounts to fulfill requirements to obtain the benefit of the offer campaign. The offer campaign of one embodiment is programmed by offer rules that identify the real time interactions with the user in response to the actions of the user, such as transactions made using any of the registered accounts of the user. The offer campaign for the user is driven at least in part by the actions of the user, such as the transactions made by the user. In one embodiment, transactions in the registered accounts of the user jointly advances the offer campaign for the user; and a milestone achieved in the offer campaign using one account of the user is recognized as a milestone achieved by the user with respect to the multiple registered accounts. Thus, the offer campaign for the user can be advanced by the user via different accounts, as if the registered accounts were a same account; and the user is not limited to using a particular account to participate in the offer campaign, nor using different accounts to drive the offer campaign separately, as if the accounts were assigned to different users.

Thus, the computing apparatus allows a cardholder having multiple account identification devices, corresponding to different consumer accounts issued by the same issuer, or different issuers, to use different account identification devices to fulfill different requirements of the offer campaign. The offer campaign can be collectively driven by the set of registered consumer accounts of the user, as if the set of registered consumer accounts were a single consumer account.

For example, in one embodiment, an offer campaign may require a user to make two purchases to get a statement credit; and the user may register two or more consumer accounts, use a first consumer account selected from the registered accounts to make the first required purchase, and use a second consumer account to make the second required purchase to get the statement credit provided by the offer campaign.

The computing apparatus of one embodiment is configured to store data identifying a group of accounts of a user. The user may identify more than one consumer account for the account group for participation in offer campaigns. The consumer accounts registered in the account group may be issued by the same issuer, or different issuers. The computing apparatus is configured to track the milestones achieved by the user based on the collective transactions in the account group, instead of separated for individual accounts. Thus, the transactions in different accounts of the user can drive the activities of the offer campaign for the user, as if the transactions were in the same consumer account. The milestones are not segregated according to the individual accounts in the account group of the user.

The offer rules of an offer of one embodiment are configured to instruct the computing apparatus to interact with the user in response to the transactions in the account group of the user. For example, in response to a first transaction that is made in a first consumer account in the account group and that satisfies one or more conditions of the offer rules of an offer campaign, the computing apparatus is configured to enroll the user in the offer campaign; in response to a second transaction that is made in a second consumer account in the account group and that satisfies one or more conditions of the offer rules of the offer campaign in which the user is enrolled based on the first transaction in the first consumer account, the computing apparatus is configured to transmit a message to the user, indicating that the user is entitled to the benefit of a discount (e.g., 10% off) for the next transaction in the offer campaign; and subsequently, in response to a third transaction that is made in a third consumer account in the account group and that satisfies one or more conditions of the offer rules of the offer campaign, the computing apparatus is configured to provide the discount to the user.

Thus, the offer rules of the offer campaign do not require the user to use a specific account in the account group to make the transaction that satisfies the requirement of the offer campaign. The offer rules of the offer campaign/offer are not based on the identity of the consumer account and/or the attribute of the consumer account. As a result, any of the accounts in the account group can have a transaction that satisfies the one or more requirements to trigger an action in the offer program, such as enrolling the user, transmitting a message to the user, providing a benefit to the user, etc.

At least one of the offer rules of the offer campaign of one embodiment is based on at least one attribute of the consumer accounts in the account group. A transaction is required to be made in a consumer account that satisfies a condition formulated based on the attributed of the consumer account. For example, the offer rule may require a transaction to be made in a consumer account issued by a particular issuer or one issuer from a particular group of issuers, in order to trigger the action in association with the transaction. For example, the offer rule may require a transaction to be made in a consumer account of a particular type, in order to trigger the action in association with the transaction. For example, the offer rule may require a transaction to be made in a consumer account having a balance, or a credit limit, over a predetermined threshold, in order to trigger the action in association with the transaction.

FIG. 7 shows a system to process offer rules in response to transactions in a plurality of accounts of a user according to one embodiment. In FIG. 7, the data warehouse (149) is configured to store data representing an account group (409) for a user (101). The account group (409) identifies one or more consumer accounts (e.g., 401, 402, . . . , 407) of the user (101). The consumer accounts (e.g., 401, 402, . . . , 407) may be issued by the same issuer, or different issuers. The consumer accounts (e.g., 401, 402, . . . , 407) may be of a same type, or different types (e.g., credit, debit, prepaid, etc., or preferred, gold, platinum, etc.).

In FIG. 7, the data warehouse (149) stores the offer (186) and its associated offer rules (203), similar to the offer rules (203) illustrated in FIG. 6.

In FIG. 7, the data warehouse (149) stores data to associate the offer (186) with the account group (409) to allow the transactions in the account group (409) to drive the actions specified in the offer rules (203) for the offer (186).

In FIG. 7, the offer (186) is associated with the account group (409) of the user (101) based on an action of the user (101). For example, in one embodiment, when the transaction profile of the user (101) satisfies the requirement of the offer (186), the offer (186) is presented to the user (101) via the media controller. The offer (186) may be presented to the user (101) in response to a transaction in the account group (409) that satisfies one or more requirements of the offer (186), or in response to the user (101) visiting the portal (143). After the user (101) accepts the offer (186), the data warehouse (149) stores data to associate the offer (186) and the account group (409) of the user (101).

After the user (101) provides a consent to receive certain types of offers (e.g., 186), the offer (186) is automatically associated with the account group (409) of the user (101), when the eligibility requirements of the offer (186) is satisfied by the user (101), without requiring the user (101) to provide input to explicitly accept the offer (186). When the offer (186) is associated with the account group (409) in the data warehouse (149), the message broker (201) is configured to generate a message for transmission to the communication reference (205) associated with the account group (409) of the user (101).

In FIG. 7, the rule engine (209) is configured to generate trigger records (207) to detect transactions that are made in the account group (409) and that satisfy the requirements for next actions in accordance with the offer rules (203). The data warehouse (149) stores data indicating the milestones (411) achieved in the account group (409) collectively as a whole.

The milestones (411) are tracked by the current position of the account group (409) in the chain of events linked by prerequisite conditions. The current position is tracked for the account group as a whole, instead of for individual accounts in the account group. Thus, the transactions in different accounts in the account group have similar opportunities to advance the current position of the account group (409) in the offer (186) or offer campaign.

Each of the trigger records (207) identifies one of the accounts (e.g., 401, 403, . . . , 407) in the account group (409). The rule engine (209) is configured to generate a trigger record (207) for each of the accounts (e.g., 401, 403, . . . , 407) in the account group (409) to detect a transaction that matches the requirement(s) of a next event following the current position in the event chain of the offer (186)/offer campaign.

When a next event following the current position has a requirement based on an attribute of the account (e.g., 401, 403, . . . , or 407), such as the type of the account, the issuer of the account, the balance of the account, the credit limit of the account, etc., the rule engine (209) is configured determine first accounts (e.g., 401, 403, . . . , 407) that satisfy the requirement, and generate trigger records for the first accounts, but not for the other accounts, to improve efficiency of the system in matching transactions with the trigger records.

The rule engine (209) can be configured to remove trigger records corresponding to the events before the current position of the account group in the event chain of the offer (186)/offer campaign, and generate trigger records corresponding to the events immediately after the current position of the account group (409) in the event chain of the offer (186)/offer campaign, as the current position of the account group (409) advances in the event chain of the offer (186)/offer campaign.

The rule engine (209) can be configured to generate only trigger records for events corresponding to transactions that are capable of being matched based on the transactions themselves. Trigger records are not generated for events that have unmet prerequisite conditions in the event change. Trigger records for events that have been matched, or cannot be matched, are removed by the rule engine (209), in response to the advance of the current position(s) of the account group (409) in the event chain of the offer (186)/offer campaign.

In general, an event chain is configured to have multiple subsequent events after the occurrence of a prerequisite event. The offer campaign may advance to one or more of the subsequent events, following the prerequisite event.

In some instances, multiple parallel subsequent events may lead to different branches or paths in the event chain of the offer (186)/offer campaign; and the milestones (411) indicate the current positions of the account group (409) on the different branches or paths.

In some instances, the benefit of the offer (186) is provided to the account in response to a transaction in that account which matches with the event that specifies the action to provide the benefit of the offer (186). For example, when a transaction in the account (403) matches the trigger record (207) for an event to provide a statement credit, the statement credit is issued to the account (403) in which the corresponding transaction occurs, although the prerequisite events were satisfied by transactions in other accounts in the account group (409), such as the account (401 or 407).

The benefit of the offer (186) can be divided among the accounts (e.g., 401, 403, . . . , 407) in which transactions occurred to advance the account group (409) to the event that provides the benefit.

For example, the data warehouse (149) is further configured to store information about the contributions of the individual accounts (e.g., 401, 403, . . . , 407) in the offer campaign. For example, the contributions can be measured based on the transaction amounts of relevant transactions made in the respective accounts (e.g., 401, 403, . . . , 407). For example, the contributions can be measured based on the number of transactions made in the respective accounts (e.g., 401, 403, . . . , 407) to satisfy the requirements for the benefit of the offer (186). For example, the contributions can be measured based on the number of items purchased via the transactions made in the respective accounts (e.g., 401, 403, . . . , 407) to satisfy the requirements for the benefit of the offer (186). For example, the contributions can be measured based on a combination of transaction amount, number of transactions, items purchased, etc.

The rule engine (209) of one embodiment is configured to divide the benefits of the offer (186) among the accounts (e.g., 401, 403, . . . , 407) in account group (409), based on the contributions of the individual accounts (e.g., 401, 403, . . . , 407).

The rule engine (209) may further be configured to provide credits to the issuers of the accounts (e.g., 401, 403, . . . , 407) for offer campaign completed for the account group, based on the contributions of the individual accounts (e.g., 401, 403, . . . , 407).

Some of the actions specified in the events for the offer (186)/offer campaign are triggered by transactions in the account group (409); some of the actions specified in the events for the offer (186)/offer campaign are triggered by user interaction with the portal (143) (e.g., via the point of interaction (107), such as a mobile computer, a mobile phone, a personal media player, etc.).

In one embodiment, a computing apparatus is configured to: store data associating a plurality of accounts (e.g., 401, . . . , 407) of a user (409); store offer rules (203) of an offer (186); determine the user (101) satisfying a first requirement of the offer rules (203) in response to a first transaction in a first account (e.g., 401) of the plurality of accounts; determine, based on the user (101) satisfying the first requirement, the user (101) satisfying a prerequisite for the detecting of a second transaction, which may occur in more than one of the plurality of accounts (e.g., 401, . . . , 407); and determine the user (101) satisfying a second requirement of the offer rules in response to the second transaction in a second account (e.g., 403) of the plurality of accounts (e.g., 401, . . . , 407).

In one embodiment, in response to the authorization request and/or response for the first or second transaction, the computing apparatus is configured to interact with the user (101) in real time, such as providing a message to the communication reference (205) of the user (101).

For example, the method to process the offer rules may include: storing, in the computing apparatus (e.g., in the data warehouse (149)), data associating a plurality of accounts (e.g., 401, 403, . . . , 407) of the user (101); storing, in the computing apparatus, offer rules (203) of an offer (186) associated with the accounts (401, 403, . . . , 407) of the user (101); determining, by the computing apparatus, the user satisfying a first requirement of the offer rules (186) of the offer (186) in response to a first transaction in a first account (e.g., 401) of the plurality of accounts (401, 403, . . . , 407) of the user (101); and determining, by the computing apparatus, the user (101) satisfying a second requirement of the offer rules (203) of the offer (186) based on: i) a second transaction in a second account (e.g., 403) of the user (101) that is different and separate from the first account (401), and ii) the user (101) satisfying the first requirement via the first transaction in the first account (401) of the user (101).

For example, the method may further include: transmitting a message identifying a benefit of the offer (186), in response to the first transaction in the first account (401), based on which the user satisfies the first requirement of the offer (186); and providing the benefit of the offer (186) to the user (101), in response to the second transaction in the second account (403) based on which the user satisfies the second requirement.

For example, the benefit may be sponsored by a merchant to provide discount, reward, cashback, and/or loyalty incentive to the user (101) when the requirements of the offer (186) are satisfied.

For example, the first account (401) and the second account (403) may be issued by different issuers; and the offer rules (203) are identified by the merchant without specifying account issuers for transactions to meet the first requirement and the second requirements.

For example, the first requirement is capable of being satisfied via a transaction in any of the plurality of accounts (401, 403, . . . , 407) of the user; and the second requirement is capable of being satisfied via a transaction in any of the plurality of accounts (401, 403, . . . , 407) of the user.

For example, the method may further include: tracking contributions of the plurality of accounts (401, 403, . . . , 407) to satisfying requirements of the offer rules (203) of the offer (186); and dividing a benefit of the offer (186) among the plurality of accounts (401, 403, . . . , 407) based on the contributions of the plurality of accounts (401, 403, . . . , 407).

Alternatively, the method may provide the entire benefit of the offer (186) to the second account (403) in accordance with the offer rules (203) of the offer (186), even when some of the requirements of the offer rules (203) are satisfied by transactions in other accounts (e.g., 401, and/or 407).

For example, the method may further include: tracking contributions of the plurality of accounts (401, 403, . . . , 407) to satisfying requirements of the offer rules (203) of the offer (186); and providing credits to issuers of the plurality of accounts (401, 403, . . . , 407) based on the contributions of the plurality of accounts.

For example, the offer rules (203) of the offer (186) can be specified by a merchant in terms of a set of events chained via prerequisite conditions. The requirements of different events can be satisfied by transactions in different accounts (401, 403, . . . , 407) in the account group (409) associated with the offer (186).

In one embodiment, some of the requirements of the offer rules (203) may include a condition formulated based on an attribute of an account used to make the qualifying transaction to satisfy the corresponding requirement(s).

For example, the attribute of the account may be based on an identity of an issuer of an account used to make the qualifying transaction.

Alternatively, or in combination, the account specific requirements may be formulated based on one or more of: an account type of an account used to make the corresponding qualifying transaction; an account balance of an account used to make the qualifying transaction; and a credit limit of an account used to make the qualifying transaction.

For example, the method may further include: receiving a user input to accept the offer (186); and storing data to associate the plurality of accounts (401, 403, . . . , 407) of the user (101) with the offer (186).

For example, the offer rules (203) of the offer (186) may be specified in terms of a set of required events chained via prerequisite conditions; and the method further includes: generating trigger records (207) to detect a first event in the set of events. The first event is capable of being satisfied via transactions in the plurality of accounts at the current milestone stage of the offer (186), in view of prior transactions relevant to the offer (186), independent of any other future transactions; and each of the trigger records is configured to detect a transaction in one of the plurality of accounts.

For example, the method may further include: in response to the first transaction, removing trigger records in accordance with prerequisite conditions in the offer rules, and/or adding trigger records in accordance with prerequisite conditions in the offer rules.

For example, a trigger record configured to monitor transactions in an account (e.g., 401, 403, . . . , 407) for the offer (186) but cannot be satisfied via a transaction in the corresponding account (e.g., 401, 403, . . . , 407) with or without a further qualifying transaction can be removed.

For example, after Event A is detected, the trigger record for detecting Event A be removed; and the trigger record for detecting subsequent Event B that requires Event A a prerequisite condition can be generated; and the trigger record for detecting Event B is not generated until the prerequisite condition of Event A is satisfied.

In one embodiment, the computing apparatus/system includes at each one of: the data warehouse (149), the transaction handler (103), the rule engine (209), the portal (143), the message broker (201), and the media controller (115), each of which may be implemented using a data processing system illustrated in FIG. 11, with more or less components.

For example, the data warehouse (149) includes at least one medium storage configured to: store data associating the plurality of accounts (401, 403, . . . , 407) of the user (101), and store offer rules (203) of the offer (186).

For example, the transaction handler (103) includes at least one processor (e.g., 173) configured to process payment transactions in payment accounts in a payment processing network, including: a first transaction in a first account (401) of the plurality of accounts (401, 403, . . . , 407) of the user (101), and a second transaction in a second account (403) of the plurality of accounts (401, 403, . . . , 407) of the user (101), where the second account (403) is separate and different from the first account (401).

For example, the rule engine (209) is coupled with the data warehouse (149) and the transaction handler (103) and configured to: determine the user satisfying a first requirement of the offer rules (203) of the offer (186) in response to the first transaction in the first account (401) of the plurality of accounts (401, 403, . . . , 407) of the user (101), and determine the user satisfying a second requirement of the offer rules (203) of the offer (186) based on: i) the second transaction in the second account (403) of the plurality of accounts (401, 403, . . . , 407) of the user (101), and ii) the user satisfying the first requirement via the first transaction in the first account (401) of the plurality of accounts (401, 403, . . . , 407) of the user (101).

For example, the offer rules (203) may be formulated based on events chained via prerequisite conditions; and the rule engine is further configured to generate and remove trigger records (207) in accordance with whether or not one or more the prerequisite conditions are satisfied by the user (101).

FIG. 8 shows a system to provide information and/or services based on transaction data (109) according to one embodiment.

In FIG. 8, the transaction handler (103) is configured in an electronic payment processing network and coupled between issuer processors (e.g., 145) in control of consumer accounts (e.g., 146) and acquirer processors (e.g., 147) in control of merchant accounts (e.g., 148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

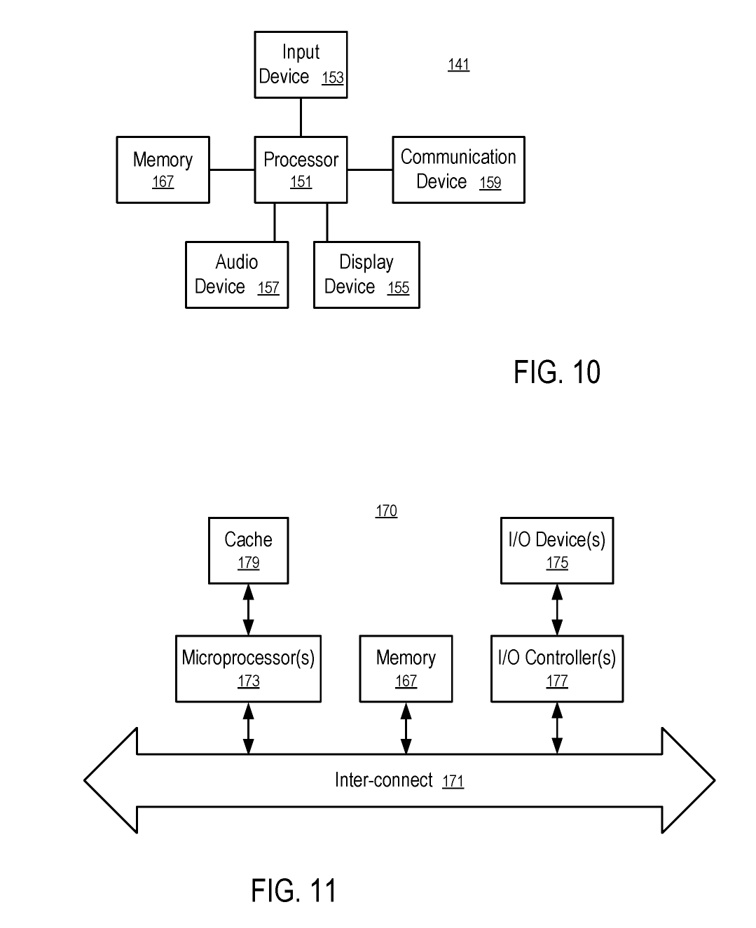

FIGS. 9 and 10 illustrate examples of transaction terminals (105) and account identification devices (141). FIG. 11 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the media controller (115), etc.

In FIG. 8, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records, such as the transaction profiles, aggregated spending profile, offer redemption notification, etc. The portal (143) may be implemented as a web portal, a telephone gateway, a file/data server, etc.

In FIG. 8, the transaction terminal (105) initiates the transaction for a user (101) (e.g., a customer) for processing by a transaction handler (103). The transaction handler (103) processes the transaction and stores transaction data (109) about the transaction, in connection with account data, such as the account profile of an account of the user (101). The account data may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

In FIG. 8, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the co account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

The transaction terminal (105) can be a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

The account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

The transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 8, the transaction handler (103) uses the data warehouse (149) to store the records about the transactions, such as the transaction records or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 8, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 8, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

FIG. 9 illustrates a transaction terminal according to one embodiment. The transaction terminal (105) illustrated in FIG. 9 can be used in various systems discussed in connection with other figures of the present disclosure. In FIG. 9, the transaction terminal (105) is configured to interact with an account identification device (141) to obtain account information (142) about the consumer account (146).

In FIG. 9, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

The reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

The input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

The output device (165) can include a display, a speaker, and/or a printer to present information, such as the result of an authorization request, a receipt for the transaction, an advertisement, etc.

The network interface (161) is configured to communicate with the acquirer processor (147) via a telephone connection, an Internet connection, or a dedicated data communication channel.

The instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In general, a transaction terminal (105) may have fewer components than those illustrated in FIG. 9. For example, in one embodiment, the transaction terminal (105) is configured for “card-not-present” transactions; and the transaction terminal (105) does not have a reader (163).

Similarly, a transaction terminal (105) may have more components than those illustrated in FIG. 9. For example, in one embodiment, the transaction terminal (105) is an ATM machine, which includes components to dispense cash under certain conditions.

FIG. 10 illustrates an account identifying device according to one embodiment. In FIG. 10, the account identification device (141) is configured to carry account information (142) that identifies the consumer account (146).

The account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

The account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

The account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

The memory (167) can include a nonvolatile memory, such as magnetic strip, a memory chip, a flash memory, a Read Only Memory (ROM), etc. to store the account information (142).

The information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

The communication device (159) of one embodiment includes a semiconductor chip to implement a transceiver for communication with the reader (163) and an antenna to provide and/or receive wireless signals.

The communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In some instances, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 10, such as a cellular communications subsystem.

In some instances, the communication device (159) may access the account information (142) stored on the memory (167) without going through the processor (151).

In general, the account identification device (141) has fewer components than those illustrated in FIG. 10. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

The account identification device (141) of one embodiment is integrated with a security device, such as an access card, a radio frequency identification (RFID) tag, a security card, a transponder, etc.

The account identification device (141) can be implemented as a handheld and compact device. For example, the account identification device (141) can be implemented with a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

The point of interaction (107) discussed in herein can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

For example, the point of interaction (107) may be the same as the transaction terminal (105), such as a point of sale (POS) terminal, an automated teller machine (ATM), a mobile phone, a computer of the user for an online transaction, etc. The point of interaction (107) may be co-located with, or near, the transaction terminal (105) (e.g., a video monitor or display, a digital sign), or produced by the transaction terminal (e.g., a receipt produced by the transaction terminal (105)). Alternatively, the point of interaction (107) may be separate from and not co-located with the transaction terminal (105), such as a mobile phone, a personal digital assistant, a personal computer of the user, a voice mail box of the user, an email inbox of the user, a digital sign, etc.

The point of interaction (107) may be used to primarily to access services not provided by the transaction handler (103), such as services provided by a search engine, a social networking website, an online marketplace, a blog, a news site, a television program provider, a radio station, a satellite, a publisher, etc.

In some instances, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 11, with more or fewer components.

The consumer device of one embodiment includes an account identification device (141). For example, a smart card used as an account identification device (141) is integrated with a mobile phone, or a personal digital assistant (PDA).

The point of interaction (107) can be integrated with a transaction terminal (105). For example, a self-service checkout terminal includes a touch pad to interact with the user (101); and an ATM machine includes a user interface subsystem to interact with the user (101).

In one embodiment, at least some of the components such as the transaction handler (103), the transaction terminal (105), the point of interaction (107), the media controller (115), the message broker (201), the portal (143), the issuer processor (145), the acquirer processor (147), the data warehouse (149), and the account identification device (141), can be implemented as a computer system, such as a data processing system (170) illustrated in FIG. 11. Some of the components may share hardware or be combined on a computer system. For example, a network of computers can be used to implement one or more of the components.

In some instances, the transaction handler (103) is a payment processing system, or a payment card processor, such as a card processor for credit cards, debit cards, etc.

In some embodiments, at least some accounts in the account groups (e.g., 13, 15, 509, 519, and 409) are virtual accounts.

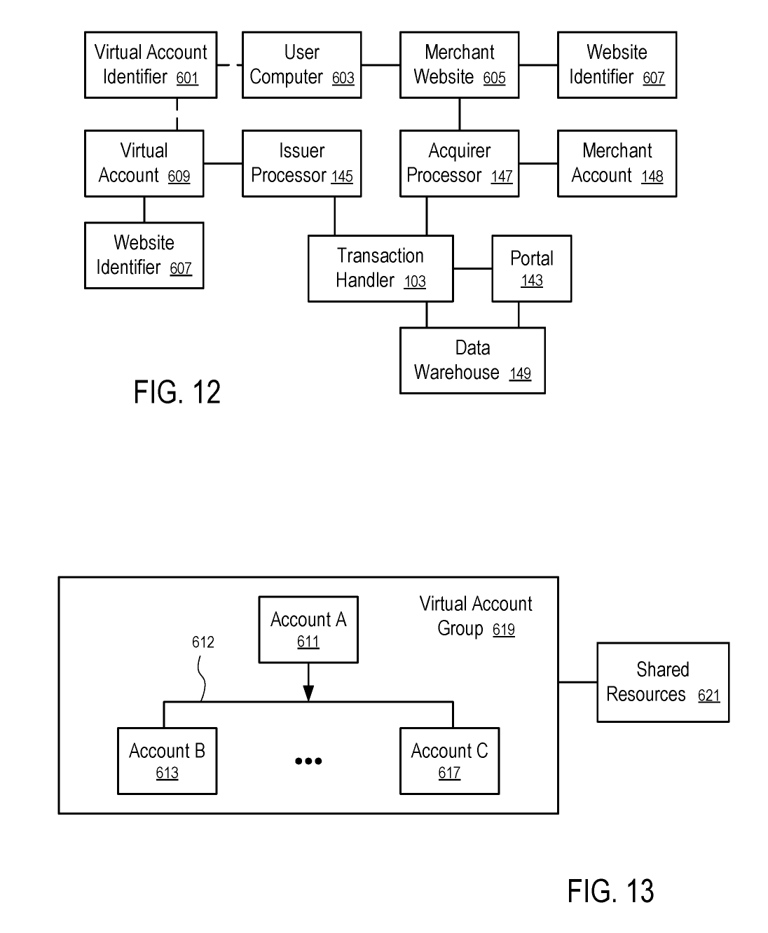

FIG. 12 shows a virtual account configured in an electronic payment processing network according to one embodiment.

In FIG. 12, a virtual account (609) is controlled by an issuer processor (145) and pre-associated with a website identifier (607) of a merchant website (605) to limit the transactions made in the virtual account (609). When the virtual account (609) is associated with the website identifier (607), the issuer processor (145) authorizes transactions made in the virtual account (609) for payments to the merchant website (605) identified by the website identifier (607) but rejects other transactions made in the virtual account (609). Thus, the use of the virtual account (609) is limited for the online payments made to the merchant website (605) identified by the website identifier (607).

For example, the virtual account (609) can be issued to a user without a corresponding physical (e.g., plastic) card for transmitting account information (e.g., from a chip or magnetic strip attached/embedded in the card) to a card reader (e.g., 163) of a transaction terminal (105). The virtual account (609) is identified by the virtual account identifier (601) in a format similar to account information (142) of a conventional consumer account (146) (non-virtual account) such that the virtual account identifier (601) can be used in the communications according to existing communication protocols in the electronic payment processing network in a communication path from the merchant website (605), to the acquirer processor (147), through the transaction handler (103), and to the issuer processor (145), in the same way as the account information (142) of a consumer account (146) that has a physical account identification device (141) being used in corresponding communications. However, the virtual account (609) is issued specifically for online payments at one or more specific websites and not for other transactions. For instance, rather than using the physical, plastic credit card (e.g., 141), a customer may use a separate virtual account for online transactions at a particular merchant website (605) (e.g., Amazon.com). The issuer processor (145) provides the virtual account (609), which is authorized for use only at the particular merchant (605) website (e.g., Amazon.com), which means that this virtual account (609) cannot be used at any other website. The restriction provides an additional level of security/safety protection in preventing fraudulent use by unauthorized persons. The user (101) of the consumer account (146) can have multiple virtual accounts (609) for different online stores (e.g., Amazon.com, Walmart.com, and Watson.com). The virtual accounts can be linked via non-replaceable connections to the consumer account (146) of the user (101) as secondary accounts in a non-replaceable group (519) to inherit account privileges and/or resources from the consumer account (146). Thus, while the addition of the virtual accounts with restrictions for transacting online with specific websites (e.g., 605) improves security, the use of virtual accounts significantly increases the number of accounts in the system; and the use of the non-replaceable group (519) to manage the resources of the virtual accounts as a group improves the efficiency in the account management of the system.

In FIG. 12, the virtual account identifier (601) includes an account number and/or an expiration date. To make a payment to the merchant website (605), the user (101) of the virtual account (609) communicates the virtual account identifier (601) to the merchant website (605) via the user computer (603). The merchant website (605) uses the virtual account identifier (501) to generate an authorization request for a transaction in the virtual account (609) and transmits the authorization request to the acquirer processor (147) that controls the merchant account (148) in which the payment is to be received in the electronic payment processing network. The authorization request includes the virtual account identifier (601) and the website identifier (607) to indicate the transaction between the merchant account (148) associated with the website identifier (607) and the virtual account (609) associated with the virtual account identifier (601). To obtain the authorization for the transaction in the virtual account (609), the acquirer processor (147) transmits the authorization request to the transaction handler (103), which is configured to route the authorization request to the issuer processor (145) based on the virtual account identifier (601) provided in the authorization request. When the website identifier (607) provided in the authorization request for the transaction in the virtual account (609) agrees with the website identifier (607) pre-associated with the virtual account (609), the issuer processor (145) may accept the transaction; otherwise, the issuer processor (145) rejects the transaction. In response to the authorization request, the issuer processor (145) generates an authorization response that includes an authorization code indicating whether the requested transaction is approved or rejected. The issuer processor (145) transmits the authorization response to the transaction handler (103), which forwards the authorization response to the acquirer processor (147), which further forwards the authorization response to the merchant website (605). The merchant website (605) then processes the payment transaction based on the authorization code obtained from the authorization response.

FIG. 12 illustrates one virtual account (609) associated with one merchant website (605) via the website identifier (607). In general, the virtual account (609) can be configured to be associated with more than one merchant website (605) via respective website identifiers (e.g., 607) of the respective merchant websites (e.g., 605) such that the use of the virtual account (609) is limited to online transactions with the respective website identifiers (e.g., 607) of the respective merchant websites (e.g., 605) but cannot be used in other transactions.

Alternatively, each virtual account (609) is associated with a single website identifier (607); and different virtual accounts (609) are associated with different websites (e.g., 605) via respective website identifiers (e.g., 607) of the respective merchant websites (e.g., 605).

FIG. 12 illustrates a merchant website (605) connected to one acquirer processor (147). In general, a plurality of merchant websites (605) can be connected to the acquirer processor (147) to receive payments via respective merchant accounts (e.g., 148).

Further, an electronic payment processing network in general has more than on acquirer processors (e.g., 147) controlling merchant accounts (e.g., 148) of respective merchant websites (605) and/or the merchant accounts (e.g., 148) of respective transaction terminals (e.g., 105) as illustrated in FIG. 8. The acquirer processors (e.g., 147) are connected to the centralized transaction handler (103) in the electronic payment processing network for communication with one or more issuer processors (e.g., 145) that control the virtual accounts (e.g., 609) and/or consumer accounts (146) as illustrated in FIG. 8.

For example, a plurality of issuer processors (e.g., 145) can be connected to the centralized transaction handler (103) of the electronic payment processing network to make payments using the accounts (e.g., 609, 146) controlled by the respective issuer processors (e.g., 145). An issuer processor (145) may control a plurality of consumer accounts (e.g., 146) and/or a plurality of virtual accounts (e.g., 609) pre-associated with website identifiers (e.g., 607).

Thus, an electronic payment processing network is not limited to the elements explicitly shown in FIGS. 8 and/or 12.

In some implementations, the website identifier (607) includes a Uniform Resource Identifier (URI) of the merchant website (605), or a domain name of the merchant website (605). In other implementations, the website identifier (607) includes an account identifier of the merchant account (148) used by the merchant website (605) to receive payments. Alternatively, the website identifier (607) include a combination of one or more data fields in authorization request messages, such as acquirer bank identification number, card acceptor, terminal ID, merchant address and/or merchant name.

FIG. 13 shows a virtual account group (619) according to one embodiment. In FIG. 13, a set of virtual accounts (e.g., 613, . . . , 617) are connected, via non-replaceable connections (612), to a primary account (611) to share a set of shared resources (621).

For example, the primary account (611) may be a non-virtual account (e.g., 146) issued to a user (101); and the virtual accounts (e.g., 613, . . . , 617) are issued to the same user (101) for online transactions with merchant websites (e.g., 605) identified by respective website identifiers (e.g., 607) pre-associated with the respective virtual accounts (e.g., 613, . . . , 617). Thus, the resources of the user (101) can be managed in connection with non-virtual account (e.g., 146) and shared with the virtual accounts (e.g., 613, . . . , 617) via the virtual account group (619).

In some instances, the primary account (611) may also be a virtual account (e.g., 609) that has resources shareable to other virtual accounts (e.g., 613, . . . , 617).

In one implementation, the shared resources (621) is linked to the virtual account group (619) directly and linked to the primary account (611) indirectly via the virtual account group (619).

In another implementation, the shared resources (621) is linked to the primary account (611) of the virtual account group (619) directly and linked to the virtual account group (619) indirectly via the primary account (611) in the virtual account group (619).

In some implementations, some of the secondary accounts (e.g, 613, . . . , 617) are not virtual accounts; and some of the secondary accounts (e.g, 613, . . . , 617) are virtual accounts (e.g., 609). Thus, a combination of virtual accounts (e.g., 609) and non-virtual accounts (e.g., 146) can be linked as the secondary accounts (e.g., 613, . . . , 617).

In some implementations, a primary account may be absent from the virtual account group (619). The shared resources (621) can be linked directly to the virtual account group (619) for propagation to the secondary accounts (e.g., 613, . . . , 617).

In one embodiment, the accounts (611, 613, . . . , 617) in the virtual account group (619) are required to be issued to the same user (101). In other embodiments, the accounts (611, 613, . . . , 617) in the virtual account group (619) may be issued to the different users (e.g., 101).

In one embodiment, a method implemented in a computing device includes; organizing, in the computing device, a plurality of accounts (611, 613, . . . , 617) into non-replaceable groups (e.g., 619), by storing, in the computing device, second data (612) linking accounts in the non-replaceable groups using non-replaceable connections among the accounts in the non-replaceable groups, where each non-replaceable group includes at least one primary account provided with privilege to propagate, within the non-replaceable group, access to resources controlled by the primary account. At least one account (e.g., 613) among the accounts in the non-replaceable groups is a virtual account (609) that is associated with a predetermined website (605), where transactions made using the virtual account (609) with a site different from the predetermined website (605) are rejected.

The method further includes: optionally updating, by the computing device, the non-replaceable groups in response to inputs from users of primary accounts in the non-replaceable groups; and tracking, by the computing device based on the non-replaceable groups, access privileges of users of the plurality of accounts in accessing resources.

For example, at least one privilege provided to the virtual account (609) is tracked via a non-replaceable group (e.g., 619) containing the virtual account (609), where the virtual account (609) has no corresponding account identification device (e.g., 141) configured to present account information (142) of the virtual account to a reader (163) of a transaction terminal (105) illustrated in FIG. 9.

For example, when the virtual account (609) is used in a payment transaction with a site different from the predetermined website, such as a transaction terminal (105) having a reader (163) disclosed in a retail store of a merchant, the transaction is to be rejected by the issuer processor (145) and/or the transaction handler (103).

For example, the non-replaceable group (e.g., 619) groups together virtual accounts (e.g., 609) of a same user (101) as the secondary accounts (613, . . . , 617) of the non-replaceable group (e.g., 619)

In one embodiment, the transaction handler (103) stores virtual account group (619) containing the primary account (611) and the second virtual accounts (613, . . . , 617). When an authorization request identifies a transaction in a virtual account (609), the transaction handler (103) determines whether the website identifier (607) provided in the authorization request matches with the website identifier (607) of the virtual account (609). If there is no match, the transaction handler (103) generates an authorization response to reject the transaction without further communicate with the issuer processor (145) that controls the virtual account (609). However, if there is a match, the transaction handler (103) updates the authorization request to indicate that the transaction is to be performed in the primary account (611) in the virtual account group (619) of the user (101).

For example, the transaction handler (103) may add to the authorization request the account information (142) of the consumer account (146) (e.g., when the primary account (611) corresponds to the consumer account (146)), before transmitting the updated authorization request to the issuer processor (145), such that the transaction requested in in the virtual account (609) is actually authorized in the non-virtual account (146) of the user (101) according to the primary account (611) of the user (101).

For example, the transaction handler (103) may replace, in the authorization request, the virtual account identifier (601) with the account information (142) of the consumer account (146) (e.g., when the primary account (611) corresponds to the consumer account (146)), before transmitting the updated authorization request to the issuer processor (145), such that the authorization request transmitted to the issuer processor (145) appears to be the same as an authorization request generated by the merchant website (605) using the account information (142) of the non-virtual account (146) of the user (101) according to the primary account (611) of the user (101).

In some embodiments, the shared resources (621) includes an offer (186), stored in the data warehouse (149) as illustrated in FIG. 7 and having a benefit applicable to the transaction requested in the authorization request; and the transaction handler (103) is configured to apply the benefit of the offer to the transaction based on the sharing permitted by the virtual account group (619) during the processing of the authorization of the requested transaction (e.g., before an authorization response for the transaction reaches the merchant website (605)).

In some embodiments, the operations of account substitution and/or offer redemption, discussed above in connection with the transaction handler, are implemented on the issue processor (145) based on the virtual account group (619).

Preferably, each of the virtual accounts (e.g., 609) is limited to be used in online transactions with a single website. Alternatively, a virtual account (e.g., 609) may be used in online transactions with a list of one or more predefined websites.

In one embodiment, the at least one privilege tracked via the account group (619) is provided to the virtual accounts (e.g., 613, . . . , 617) in the group (619) from a primary account (611) of the non-replaceable group (619). The primary account (611) is a non-virtual account in one embodiment, and a virtual account in another embodiment. When the primary account (611) is a non-virtual account, the primary account (611) has a corresponding account identification device (141) configured to present an account identifier (e.g., 142) of the primary account (e.g., 146) to readers (e.g., 163) of transaction terminals (105) disposed at different merchant locations; and the primary account (611) can be used not only in online transactions but also in offline transactions at retail locations in physical stores of merchants.

In some embodiments, virtual accounts can also be connected via replaceable links in replaceable groups.

In general, the accounts in the account groups (e.g., 13, 15, 619, 409, 509, 519) can be accounts of various types, such as accounts in a social networking site, payment accounts in an electronic payment processing system, virtual accounts limited for payment transactions on websites, etc. A user interface can be provided (e.g., via a portal (143), the user computers (603), and/or mobile applications) to users of primary accounts (e.g., 611) to receive the inputs from the users of the primary accounts. The inputs specify the propagation of access privileges of the users of the primary accounts, such as sharing of access privileges to offers, benefits, and/or other resources controlled by the users of the primary accounts. In general, a given account can be in more than one account group, including a replaceable group and a non-replaceable group.

One embodiment of the disclosure includes a non-transitory computer storage media storing instructions configured to instruct a computing device to perform any of the methods discussed above.

One embodiment of the disclosure includes a computing device having: at least one microprocessor; and a memory storing instructions configured to instruct the at least one microprocessor to perform any of the methods discussed above.

Some of the components illustrated in systems discussed above can be implemented via one or more data processing systems via hardware and/or software.

FIG. 11 illustrates a data processing system according to one embodiment. While FIG. 11 illustrates various components of a computer system, it is not intended to represent any particular architecture or manner of interconnecting the components. One embodiment may use other systems that have fewer or more components than those shown in FIG. 11.

In FIG. 11, the data processing system (170) includes an inter-connect (171) (e.g., bus and system core logic), which interconnects a microprocessor(s) (173) and memory (167). The microprocessor (173) is coupled to cache memory (179) in the example of FIG. 11.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method, comprising:
organizing, in a computing device, a plurality of accounts into non-replaceable groups, by
storing, in the computing device, second data linking accounts in the non-replaceable groups using non-replaceable connections among the accounts in the non-replaceable groups, wherein each non-replaceable group includes at least one primary account provided with privilege to propagate, within the non-replaceable group, access to resources controlled by the primary account;
wherein at least one account among the accounts in the non-replaceable groups is a virtual account that is associated with a predetermined website; and
wherein transactions made using the virtual account with a site different from the predetermined website are rejected;
updating, by the computing device, the non-replaceable groups in response to inputs from users of primary accounts in the non-replaceable groups; and
tracking, by the computing device based on the non-replaceable groups, access privileges of users of the plurality of accounts in accessing resources.

2. The method of claim 1, wherein at least one privilege provided to the virtual account is tracked via a non-replaceable group containing the virtual account.

3. The method of claim 2, wherein the virtual account has no corresponding account identification device configured to present account information of the virtual account to a reader of a transaction terminal.

4. The method of claim 2, wherein the site different from the predetermined website includes a transaction terminal having a reader in a retail store.

5. The method of claim 2, wherein the non-replaceable group containing the virtual account groups together virtual accounts of a same user.

6. The method of claim 5, wherein each of the virtual accounts is limited to be used in online transactions with a respective website.

7. The method of claim 5, wherein each of the virtual accounts is limited to be used in online transactions with one or more predefined websites.

8. The method of claim 5, wherein the at least one privilege is provided to the virtual account from a primary account of the non-replaceable group containing the virtual account.

9. The method of claim 5, wherein the primary account is a virtual account.

10. The method of claim 5, wherein the primary account is an account having a corresponding account identification device configured to present an account identifier of the primary account to a reader of a transaction terminal.

11. The method of claim 1, further comprising:
organizing, in the computing device, the plurality of accounts into replaceable groups, by
storing, in the computing device, first data linking accounts in the replaceable groups using replaceable connections between replaced accounts and replacement accounts, wherein each replacement account, connected via a replaceable connection to a replaced account in a replaceable group, is provided, in connection with the replaceable group, with access to resources of the replaced account;
tracking, by the computing device further based on the replaceable groups, access the privileges of users of the plurality of accounts in accessing resources.

12. The method of claim 1, wherein the plurality of accounts include accounts in a social networking site and payment accounts in an electronic payment processing system.

13. The method of claim 1, further comprising:
providing, by the computing device, a user interface to the users of the primary accounts; and
receiving, in the computing device using the user interface, the inputs from the users of the primary accounts.

14. The method of claim 13, wherein the inputs specify propagation of access privileges of the users of the primary accounts.

15. The method of claim 14, wherein the propagation includes sharing of access privileges.

16. The method of claim 14, wherein the propagation includes distribution of resources controlled by the users of the primary accounts.

17. The method of claim 14, wherein the propagation includes sharing or redistribution of resources controlled by the users of the primary accounts.

18. The method of claim 1, wherein at least one account is in more than one account group, including a replaceable group and a non-replaceable group.

19. A non-transitory computer storage media storing instructions configured to instruct a computing device to perform a method, comprising:
organizing, in the computing device, a plurality of accounts into non-replaceable groups, by
storing, in the computing device, second data linking accounts in the non-replaceable groups using non-replaceable connections among the accounts in the non-replaceable groups, wherein each non-replaceable group includes at least one primary account provided with privilege to propagate, within the non-replaceable group, access to resources controlled by the primary account;
wherein at least one account among the accounts in the non-replaceable groups is a virtual account that is associated with a predetermined website; and
wherein transactions made using the virtual account with a site different from the predetermined website are rejected;
updating, by the computing device, the non-replaceable groups in response to inputs from users of primary accounts in the non-replaceable groups; and
tracking, by the computing device based on the non-replaceable groups, access privileges of users of the plurality of accounts in accessing resources.

20. A computing device, comprising:
at least one microprocessor; and
a memory storing instructions configured to instruct the at least one microprocessor to:
organize, in a computing device, a plurality of accounts into non-replaceable groups, by
storing, in the computing device, second data linking accounts in the non-replaceable groups using non-replaceable connections among the accounts in the non-replaceable groups, wherein each non-replaceable group includes at least one primary account provided with privilege to propagate, within the non-replaceable group, access to resources controlled by the primary account;
wherein at least one account among the accounts in the non-replaceable groups is a virtual account that is associated with a predetermined website; and
wherein transactions made using the virtual account with a site different from the predetermined website are rejected;
update, by the computing device, the non-replaceable groups in response to inputs from users of primary accounts in the non-replaceable groups; and
track, by the computing device based on the non-replaceable groups, access privileges of users of the plurality of accounts in accessing resources.
